(19) United States
(12) Patent Application Publication
(10) Pub. No.: US 2020/0178575 A1
(43) Pub. Date: Jun. 11, 2020

(54) HIGH HYDROSTATIC PRESSURE PROCESSING METHOD AND APPARATUS

(71) Applicant: TECHNOLOGY ON PROTOTYPING ULTIMATE CO., LTD., Kaohsiung City (TW)

(72) Inventors: Hui Wen HU, Kaohsiung City (TW); Chun Yen WEI, Kaohsiung City (TW)

(73) Assignee: TECHNOLOGY ON PROTOTYPING ULTIMATE CO., LTD., Kaohsiung City (TW)

(21) Appl. No.: 16/392,923

(22) Filed: Apr. 24, 2019

(30) Foreign Application Priority Data
Dec. 11, 2018 (TW) 107144493

(51) Int. Cl. A23L 3/00; A23L 3/015; G06K 9/46; G06T 7/00; G06T 7/90

(52) U.S. Cl. CPC A23L 3/003; A23L 3/001; A23L 3/0155; G06T 2207/30128; G06T 7/0002; G06T 7/90; A23V 2002/00; G06K 9/4652

(57) ABSTRACT

A high hydrostatic pressure processing method, applied for food processing, comprises capturing the first image of a food material, obtaining the first color parameter according to the first image and storing the first color parameter into the first food quality parameter group, performing the first high-pressure-process on the food material according to the first food quality parameter group so as to obtain an intermediate product, capturing the second image of the intermediate product, obtaining the second color parameter according to the second image and storing the second color parameter into the second food quality parameter group, and performing the second high-pressure-process on the intermediate product according to the second food quality parameter group and a sterilization standard.

### CROSS-REFERENCE TO RELATED APPLICATIONS

This non-provisional application claims priority under 35 U.S.C. § 119(a) on Patent Application No(s). 107144493 filed in Taiwan, R.O.C. on Dec. 11, 2018, the entire contents of which are hereby incorporated by reference.

### BACKGROUND

### 1. Technical Field

This disclosure relates to a food processing method, and particularly to a high hydrostatic pressure processing.

### 2. Related Art

Nowadays, network communication is . . . During food processing, a conventional high-temperature sterilization technology usually leads to deterioration of a food material, which causes the food material to lose its original flavor and nutrients. Therefore, in recent years, high pressure processing (HPP) technology has been developed to perform food sterilization to replace the high-temperature sterilization technology. The high pressure processing technology is also known as high hydrostatic pressure processing (HHP) technology, wherein high pressure is transmitted to the food material through fluid to destroy the cell membrane of microorganisms and to cause degradation of enzyme associated with reproduction, causing the microorganisms to die or lose the ability to split and grow; thereby, a sterilization effect is achieved.

For a good sterilization effect, the pressure value required for the high pressure processing technology to provide the food material is quite high. Although the high pressure processing technology does not cause the loss of nutrients due to high temperature, the extremely high pressure applied at one time may cause the change in the composition of the food material, and the color or texture of the food material may be changed significantly, so that consumers may suspect the freshness of the food material and reduce their willingness to purchase it.

### SUMMARY

According to one or more embodiment of this disclosure, a high hydrostatic pressure processing method is applied for food processing. Said method comprises capturing the first image of a food material, obtaining the first color parameter according to the first image and storing the first color parameter into the first food quality parameter group, performing the first high-pressure-process on the food material according to the first food quality parameter group so as to obtain an intermediate product, capturing the second image of the intermediate product, obtaining the second color parameter according to the second image and storing the second color parameter into a second food quality parameter group, and performing the second high-pressure-process on the intermediate product according to the second food quality parameter group and a sterilization standard.

According to one or more embodiment of this disclosure, a high hydrostatic pressure processing apparatus is applied for food processing. Said apparatus comprises an image capturing assembly, a pressurizer, a memory and a central processing controller. The image capturing assembly is configured to capture the first image of a food material. The pressurizer is configured to perform high pressure processing on the food material. The memory stores the first food quality parameter group and the second food quality parameter group. The central processing controller is connected with the image capturing assembly, the pressurizer and the memory. The central processing controller obtains the first color parameter according to the first image and storing the first color parameter into the first food quality parameter group, controlling the pressurizer to perform the first high-pressure-process on the food material according to the first food quality parameter group so as to obtain the intermediate product. The central processing controller controls the image capturing assembly to capture the second image of the intermediate product so as to obtain the second color parameter and store the second color parameter into the second food quality parameter group, and controls the pressurizer to perform the second high-pressure-process on the intermediate product according to the second food quality parameter group and a sterilization standard.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram of a high hydrostatic pressure processing apparatus according to an embodiment of this disclosure;

FIG. 2 is a flow chart of a high hydrostatic pressure processing method according to an embodiment of this disclosure;

FIG. 3 is a functional block diagram of a high hydrostatic pressure processing apparatus according to another embodiment of this disclosure; and

FIG. 4 is a flow chart of a high hydrostatic pressure processing method according to another embodiment of this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

A high hydrostatic pressure processing apparatus provided by the embodiment of this disclosure is applied for food processing, wherein a food material is sterilized by high pressure processing (HPP) instead of high temperature sterilization, so as to maintain the nutrient content and the freshness of the food material. The food material can be a mean product (e.g. pork), a soy product (e.g. soy milk), a dairy product (e.g. cheese), a fermented product (e.g. soy sauce), a fruit and vegetable product (e.g. juice) or other processed food material. In the following embodiment, one or more kinds of food materials are exemplarily mentioned for describing the high hydrostatic pressure processing apparatus and method of this disclosure. However, the food material applied for the high hydrostatic pressure processing apparatus and method is not limited to these.

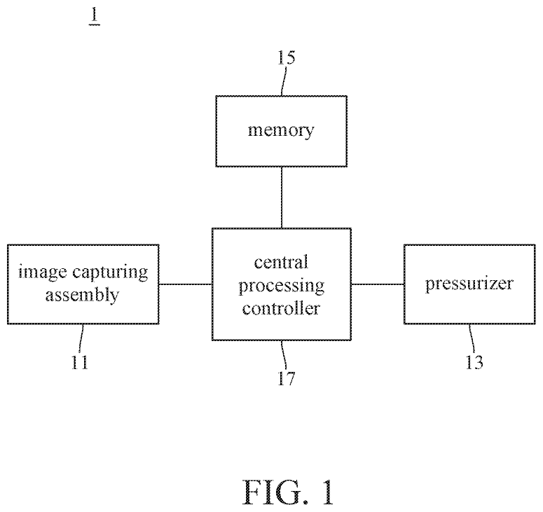

Please refer to FIG. 1, which is a functional block diagram of a high hydrostatic pressure processing apparatus 1 according to an embodiment of this disclosure. As shown in FIG. 1, the high hydrostatic pressure processing apparatus 1 comprises an image capturing assembly 11, a pressurizer 13, a memory 15 and a central processing controller 17, wherein the central processing controller 17 is connected with the image capturing assembly 11, the pressurizer 13 and the memory 15.

The image capturing assembly 11 is configured to capture an image of a food material. For example, the image capturing assembly 11 can be a camera and capture an image of a food material by shooting. More particularly, the image capturing assembly 11 can capture the original image of the food material before high pressure processing according to an instruction from the central processing controller 17 or an external control instruction, and this original image serves as the first image. For example, the external control instruction can be the control instruction triggered by a user through the user interface of the touch screen. In another embodiment, the image capturing assembly 11 can comprise a sensor (e.g. infrared sensor). The sensor can generate a control instruction when a food material is just placed in the high hydrostatic pressure processing apparatus 1, so as to control the image capturing assembly 11 to capture the first image by shooting. The image capturing assembly 11 can also capture an image of the food material being processed by the first high-pressure-process according to an instruction from the central processing controller 17 or an external control instruction, and this image serves as the second image. Moreover, the image capturing assembly 11 can also comprise a number of cameras respectively disposed in different positions in the high hydrostatic pressure processing apparatus 1. For example, the image capturing assembly 11 can comprise two cameras respectively disposed at the feeding end and the discharging end of the pressurizer 13, so as to respectively capture the images of the food material before and after the high pressure processing by shooting.

The pressurizer 13 is controlled by the central processing controller 17, and can pressurize the food material with liquid (e.g. water) as a medium for transmitting pressure. In another embodiment, the pressurizer 13 can comprise a liquid pressure source and a gas pressure source, and use a liquid and a gas together as a fluid medium for pressure transmission. In yet another embodiment, the pressurizer 13 can comprise a temperature regulator to regulate the temperature of the liquid by heating or/and cooling. More particularly, besides providing pressure to the food material by the fluid medium, the pressurizer 13 can also provide different temperature environments to the food material by the fluid medium. In yet another embodiment, the pressurizer 13 can comprise a liquid pressure source, a gas pressure source and a pH regulator. The gas pressure source can supply one or both of an acid gas (e.g. CO2) and an alkaline gas. The pH regulator can control the content of the acid gas or/and the alkaline gas in the fluid medium so as to regulate its pH value. More particularly, the package of the food material to be processed can be a membrane through which the fluid medium can pass; or, the food material can be placed in the high hydrostatic pressure processing apparatus 1 without packaging. Therefore, the pressurizer 13 can regulate the pH value of the food material by regulating the pH value of the fluid value.

The memory 15 is, for example, flashing memory, read-only memory, magnetic memory or other non-volatile storage medium. The memory 15 can be electrically connected with the central processing controller 17, or be a database in a cloud server which has a communication connection with the central processing controller 17. The memory 15 stores the first food quality parameter group, the second food quality parameter group and multiple preset standards. Said multiple preset standards include a sterilization standard, a preset color parameter, a preset quality standard, etc. The use of these preset standards will be described in details later. The memory 15 can also store multiple lookup tables including a food category lookup table, a color change lookup table, a sterilization degree lookup table, a hardness change lookup table, a pH change lookup table, etc. The use of these lookup tables will be described in details later. Moreover, the memory 15 can be directly connected with the image capturing assembly 11 to store the images captured by the image capturing assembly 11.

The central processing controller 17 is, for example, a central processing unit, a microcontroller, a field programmable gate array, an application specific integrated circuit or other processor. The central processing controller 17 obtains the first color parameter according to the first image captured by the image capturing assembly 11, and store it into the first food quality parameter group of the memory 15. The central processing controller 17 controls the pressurizer 13 to perform the first high-pressure-process on the food material to obtain the intermediate product according to the first food quality parameter group, and then controls the image capturing assembly 11 to capture the second image of the intermediate product so as to obtain the second color parameter and store it into the second food quality parameter group in the memory 15. The central processing controller 17 controls the pressurizer 13 to perform the second high-pressure-process on the intermediate product according to the second food quality parameter group and the sterilization standard pre-stored in the memory 15. The detailed operating method will be described later.

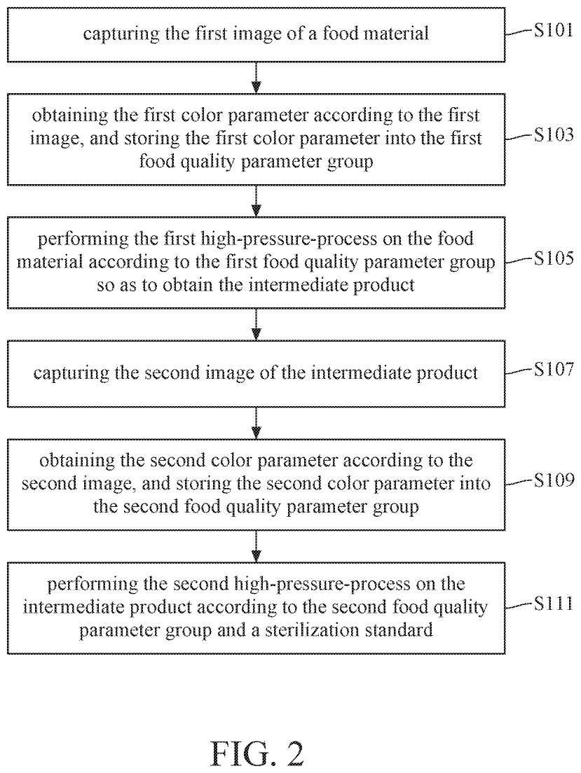

Please refer to FIG. 1 and FIG. 2, wherein FIG. 2 is a flow chart of a high hydrostatic pressure processing method according to an embodiment of this disclosure. The high hydrostatic pressure processing method as shown in FIG. 2 can be performed by the high hydrostatic pressure processing apparatus 1 as shown in FIG. 1. In the following, the operation of the high hydrostatic pressure processing method of an embodiment of this disclosure is exemplarily described by the high hydrostatic pressure processing apparatus 1. In step S101, the image capturing assembly 11 captures the first image of a food material.

In step S103, the central processing controller 17 can perform image analysis on the first image of the food material and perform the operation of the color of the food material so as to obtain the first color parameter. In another embodiment, besides obtaining the color parameter according to the first image, the central processing controller 17 can further determine which food category the food material belongs to according to the first image, and stores the determined food category into the first food quality parameter group. As previously described, the memory 15 can store a food category lookup table therein. The food category lookup table can record multiple food categories and image recognition data respectively corresponding to these food categories. Moreover, the food category of the food material can also be inputted into the high hydrostatic pressure processing apparatus 1 by a user through a user interface.

In step S105, the central processing controller 17 can set the pressure value which the pressurizer 13 uses to perform the first high-pressure-process on the food material according to the result of comparing the first color parameter with the preset color parameter. As aforementioned, the memory 15 can stores a color change lookup table which records multiple color change levels (such as brighten one color level, darken two color levels, etc.) and the applied pressure values respectively corresponding to these color change levels. The central processing controller 17 can obtain the applied pressure value corresponding to the difference between the first color parameter and the preset color parameter (i.e. color change level) by the color change lookup table, and set this applied pressure value as the pressure value of the first high-pressure-process.

The above preset color parameter represents the target color of the food material, with the target color usually indicates the color that are more acceptable to consumers, or the color that is similar to the original color of the food material. In an embodiment, a lookup table can record multiple food categories and the preset color parameters respectively corresponding to these food categories. The central processing controller 17 obtains the preset color parameter corresponding to the food material to be processed according to this lookup table and then perform the comparison as aforementioned. In another embodiment, the central processing controller 17 can generate a color range according to the first color parameter (for example, the color range includes the color levels from two levels brighter than the color level corresponding to the first color parameter to two levels darker than the color level corresponding to the first color parameter), and then determine the preset color parameter according to a control instruction triggered by, for example, a user through a user interface. More specifically, the central processing controller 17 can present the color range through the user interface for the user to select. The preset color parameter is in the aforementioned color range, and can be a single color number or a range of color numbers.

In step S107, after determining that the pressurizer 13 has performed the first high-pressure-process, the central processing controller 17 controls the image capturing assembly 11 to shoot the food material processed by the first high-pressure-process (i.e. intermediate product) so as to obtain the second image. In step S109, the central processing controller 17 obtains the second color parameter according to the second image, and stores the second color parameter into the second food quality parameter group in the memory 15.

In step S111, the central processing controller 17 can set the pressure value which the pressurizer 13 uses to perform the second high-pressure-process on the intermediate product according to the result of comparing the second color parameter with the preset color parameter and the result of comparing the bacterial/fungous content of the intermediate product with the preset sterilization standard. The details about the comparison of the color parameter is similar to the aforementioned step S105, and are not repeated herein.

In detailed description of the comparison between the bacterial/fungous content and the sterilization standard, the memory 15 can store a sterilization degree lookup table therein, and this sterilization degree records multiple applied pressure values and sterilization degrees respectively corresponding to the applied pressure values. The central processing controller 17 can determines the bacterial/fungous content of the intermediate product according to the pressure value of the first high-pressure-process and the above lookup table. More particularly, the same pressure value may have different sterilization effects on different species of bacteria and fungi (e.g. E. coli, cell spores, etc.), so the sterilization degree lookup table can further record the relationships among multiple species of bacteria and fungi, applied pressure values and sterilization degrees, and the aforementioned food category lookup table can record the fungi or bacteria that easily breed in each food category. Therefore, the central processing controller 17 can obtain the fungi or bacteria corresponding to the category of the intermediate product, and determine the bacterial/fungous content of the intermediate product which has been processed by the first high-pressure-process according to the relationship between the applied pressure value and the sterilization degree corresponding to said fungi or bacteria. In another embodiment, the high hydrostatic pressure processing apparatus 1 can further comprise a detector for detecting the food bacterial/fungous content so as to obtain the bacterial/fungous content of the intermediate product. Moreover, a single sterilization standard or multiple sterilization standards corresponding to different food categories can also be stored in the memory 15 for the central processing controller 17 to perform the determining procedure.

When the central processing controller 17 determining the bacterial/fungous content of the intermediate product, the central processing controller 17 compares it with a single sterilization standard or the sterilization standard corresponding to the food category to which the food material belongs. The difference obtained by the comparison represents the degree of sterilization still required for the intermediate product. The central processing controller 17 can obtain the applied pressure value corresponding to said degree of sterilization still required for the intermediate product according to the aforementioned sterilization degree lookup table, Therefore, in step S111, the central processing controller 17 obtains the applied pressure value corresponding to the comparison result of the color parameter (called the first applied pressure value hereafter) and the applied pressure value corresponding to the comparison result of the sterilization degree (called the second applied pressure value hereafter), and calculates the pressure value of the second high-pressure-process according to a preset weight. The preset weight can be set by a user through a user interface. In particular, since the original main function of the high hydrostatic pressure processing method is to sterilize food materials, the weight of the second applied pressure value is preferably higher than the weight of the first applied pressure value.

By the aforementioned implementation of the high pressure sterilization, most of the bacteria such as Escherichia coli can be removed, but the spores of the molds may not be eradicated because they have not yet germinated. For the better sterilization effect, in another embodiment, before step S111 is performed, the high hydrostatic pressure processing apparatus 1 can further put the intermediate product in a preset temperature environment for a preset time period. More specifically, the central processing controller 17 can control the temperature regulator of the pressurizer 13 to regulate the temperature of the fluid medium so as to provide said preset temperature environment for the intermediate product, and perform step S111 after said preset time period. Said preset temperature environment and said preset time period are determined by the suitable germination environment and time of the spores contained in the food material, and the invention does not limit it. By the above steps, the subsequent second high-pressure-process can also remove the mold contained in the food material, thereby achieving the better sterilization effect.

By the aforementioned steps S101-S111, the color can be the determined parameter of the pressure value of the first high-pressure-process, and the pressure value of the second high-pressure-process can be mainly based on the sterilization degree. Therefore, severe whitening (such as pork) or color change caused by a one-time high pressure processing may be avoided, and the same sterilization effect as the one-time high pressure processing may be achieved. In another embodiment, after the second high-pressure-process of the food material is finished, the aforementioned steps S107-S111 can be repeated for more times of high pressure processing of the food material.

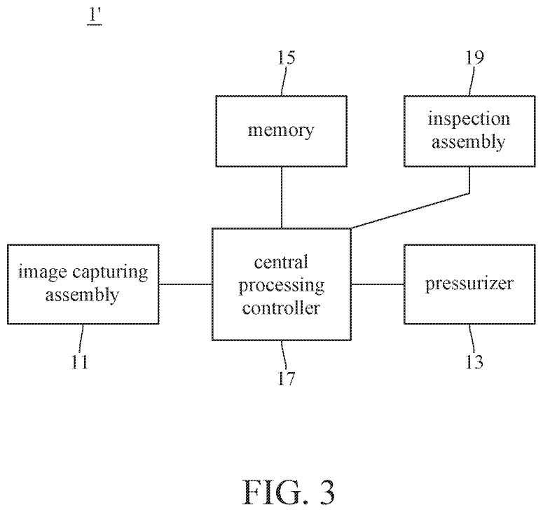

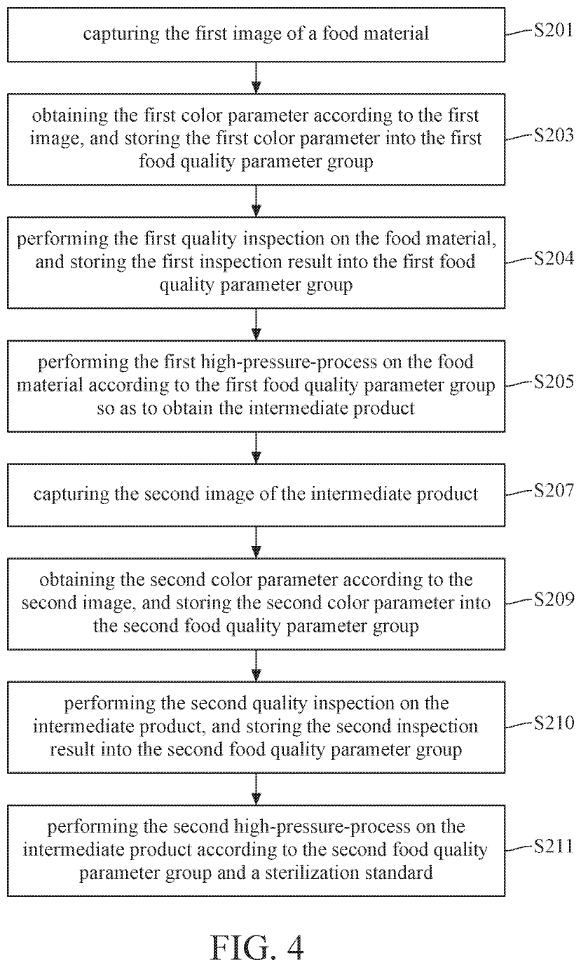

In another embodiment, besides the color parameters, the food quality parameter group can also comprise other inspection parameters. Please refer to FIG. 3 and FIG. 4, wherein FIG. 3 is a functional block diagram of a high hydrostatic pressure processing apparatus 1′ according to another embodiment of this disclosure, and FIG. 4 is a flow chart of a high hydrostatic pressure processing method that can be performed by the high hydrostatic pressure processing apparatus 1′.

The high hydrostatic pressure processing apparatus 1′ shown in FIG. 3, similar to the high hydrostatic pressure processing apparatus 1 in the aforementioned embodiment of FIG. 1, comprises an image capturing assembly 11, a pressurizer 13, a memory 15 and a central processing controller 17. The connections among these components and their operating method are similar to those in the aforementioned embodiment of FIG. 1, so they are not repeated herein. In the embodiment of FIG. 3, besides the above components, the high hydrostatic pressure processing apparatus 1′ further comprises an inspection assembly 19 which is electrically connected with the central processing controller 17 and the memory 15. The inspection assembly 19 is controlled by the central processing controller 17, and is configured to perform quality inspection on the food material processed by high pressure. The central processing controller 17 stores the quality inspection result (i.e. “other inspection parameters” mentioned before). More particularly, the inspection assembly 19 can comprise one or both of a hardness tester and a pH meter.

The high hydrostatic pressure processing method shown in FIG. 4 is applied to the high hydrostatic pressure processing apparatus 1′ shown in FIG. 3, and is similar to the high hydrostatic pressure processing method shown in FIG. 2. In comparison with the high hydrostatic pressure processing method shown in FIG. 2, besides the color parameters, the high hydrostatic pressure processing method shown in FIG. 3 performs high pressure processing on the food material further according to other inspection parameters.

In this embodiment, before executing step S205 (corresponding to step S105 in FIG. 2) for performing the first high-pressure-process on the food material, the central processing controller 17 controls the inspection assembly 19 to perform the first quality inspection on the food material, and stores the first inspection result into the memory 15. The sequence of steps S204, S201 and S203 are not limited to the above in this disclosure.

More particularly, in step S205, the central processing controller 17 can set the pressure value of the first high-pressure-process according to the result of comparing the first color parameter with the preset color parameter and the result of comparing the first quality inspection result with the preset quality standard. In another embodiment, the memory 15 stores the preset quality standard which comprises a hardness standard or/and a pH standard. For example, the preset quality standard can be stored as a lookup table. More specifically, this lookup table can record multiple food categories and preset quality standards respectively corresponding to the food categories. The central processing controller 17 can obtain the preset quality standard corresponding to the food material to be processed according to this lookup table. In another embodiment, the preset quality standard can be set by a user through a user interface.

As aforementioned, the central processing controller 17 can obtain the applied pressure value corresponding to the difference between the hardness test result in the first quality inspection and the hardness standard by the hardness change look-up table. The central processing controller 17 can obtain the applied pressure value corresponding to the difference between the pH test result in the first quality inspection and the pH standard. Therefore, in step S205, the central processing controller 17 obtains the applied pressure value corresponding to the comparison result of the color parameter and one or both of the applied pressure value corresponding to the comparison result of the hardness parameter and the applied pressure value corresponding to the comparison result of the pH parameter, and then calculates the pressure value of the first high-pressure-process according to the first preset weight. Said first preset weight can be set by a user through a user interface.

In step S207, the image capturing assembly 11 captures the second image of the intermediate product. In step S209, the central processing controller 17 obtains the second color parameter according to the second image, and stores the second color parameter into the memory 15. In this embodiment, before step S211 (corresponding to step S111 shown in FIG. 2) is executed to perform the second high-pressure-process on the food material according to the second food quality parameter group and the sterilization standard, the central processing controller 17 controls the inspection assembly 19 to perform the second quality inspection on the food material, and stores the second quality inspection result into the second food quality parameter group in the memory 15, as described in step S210. The sequence of steps S210, S207 and S209 are not limited to the above in this disclosure.

Particularly describing step S211, the central processing controller 17 can set the pressure value of the second high-pressure-process according to the result of comparing the first color parameter with the preset color parameter, the result of comparing the second quality inspection result with the preset quality standard, the result of comparing the bacterial/fungous content of the intermediate product with the sterilization standard. In this step, the central processing controller 17 obtains multiple pressure values respectively corresponding to the above comparison results, and then calculates the pressure value of the second high-pressure-process according to the second preset weight. Said second preset weight can be set by a user through a user interface.

By the aforementioned steps S201-S211, the pressure value of the first high-pressure-process can be determined by a user considering the aforementioned weight of the parameters through the high hydrostatic pressure processing apparatus 1′, and the sterilization degree can be set as the main determined parameter of the pressure value of the second high-pressure-process. Therefore, a severe color change or texture change caused by a one-time high pressure processing may be avoided, and the same sterilization effect as the one-time high pressure processing may be achieved. In another embodiment, after the second high-pressure-process of the food material is finished, the aforementioned steps S207-S211 can be repeated for more times of high pressure processing of the food material.

In view of the above description, the high hydrostatic pressure processing apparatus and method provided by this disclosure can respectively capture the images of the food material before and after the high pressure processing, and perform multiple times of high pressure processing according to the analysis results of the images, so as to adjust the color of the food material. Therefore, a sharp color change caused by a one-time high pressure processing may be avoided, and the same sterilization effect as the one-time high pressure processing may be achieved. More particularly, the high hydrostatic pressure processing apparatus and method provided by this disclosure can further respectively perform quality inspection on the food material before and after the high pressure processing, and set the inspection results as one kind of the operational parameters of the high pressure processing, so as to slightly adjust the color and the quality of the food material by multiple times of the high pressure processing. Therefore, the food material may maintain the desired color and quality during the processing, and have a good sterilization effect.

What is claimed is:

1. A high hydrostatic pressure processing method, applied for food processing, comprising:
capturing a first image of a food material;
obtaining a first color parameter according to the first image, and storing the first color parameter into a first food quality parameter group;
performing a first high-pressure-process on the food material according to the first food quality parameter group so as to obtain an intermediate product;
capturing a second image of the intermediate product;
obtaining a second color parameter according to the second image, and storing the second color parameter into a second food quality parameter group; and
performing a second high-pressure-process on the intermediate product according to the second food quality parameter group and a sterilization standard.

2. The method according to claim 1, wherein performing the first high-pressure-process on the food material according to the first food quality parameter group so as to obtain the intermediate product comprises:
setting a pressure value of the first high-pressure-process according to a result of comparing the first color parameter with a preset color parameter;
wherein performing the second high-pressure-process on the intermediate product according to the second food quality parameter group and the sterilization standard comprises:
setting a pressure value of the second high-pressure-process according to a result of comparing the second color parameter with the preset color parameter and a result of comparing a bacterial/fungous content of the intermediate product with the sterilization standard.

3. The method according to claim 2, further comprising:
generating a color range according to the first color parameter; and
determining the preset color parameter according to a control instruction, wherein the preset color parameter is in the color range.

4. The method according to claim 1, further comprising:
before performing the first high-pressure-process on the food material, performing a first quality inspection on the food material and storing a first quality inspection result into the first food quality parameter group; and
before performing the second high-pressure-process on the intermediate product, performing a second quality inspection on the intermediate product and storing a second quality inspection result into the second food quality parameter group;
wherein performing the first high-pressure-process on the food material according to the first food quality parameter group so as to obtain the intermediate product comprises:
setting a pressure value of the first high-pressure-process according to a result of comparing the first color parameter with a preset color parameter and a result of comparing the first quality inspection result with a preset quality standard;
wherein performing the second high-pressure-process on the intermediate product according to the second food quality parameter group and the sterilization standard comprises:
setting a pressure value of the second high-pressure-process according to a result of comparing the second color parameter with the preset color parameter, a result of comparing the second quality inspection result with the preset quality standard and a result of comparing a bacterial/fungous content of the intermediate product with the sterilization standard.

5. The method according to claim 4, wherein each of the first quality inspection and the second quality inspection comprises one or both of a hardness test and a pH test.

6. The method according to claim 1, further comprising:
determining that the food material belongs to a food category according to the first image, and storing the food category into the first food quality parameter group.

7. The method according to claim 1, wherein before capturing the second image of the intermediate product, the method further comprises:
putting the intermediate product in a preset temperature environment for a preset time period.

8. A high hydrostatic pressure processing apparatus, applied for food processing, comprising:
an image capturing assembly configured to capture a first image of a food material;
a pressurizer configured to perform high pressure processing on the food material;
a memory, storing a first food quality parameter group and a second food quality parameter group; and
a central processing controller connected with the image capturing assembly, the pressurizer and the memory, obtaining a first color parameter according to the first image and storing the first color parameter into the first food quality parameter group, controlling the pressurizer to perform a first high-pressure-process on the food material according to the first food quality parameter group so as to obtain an intermediate product, controlling the image capturing assembly to capture a second image of the intermediate product so as to obtain a second color parameter and store the second color parameter into the second food quality parameter group, and controlling the pressurizer to perform a second high-pressure-process on the intermediate product according to the second food quality parameter group and a sterilization standard.

9. The apparatus according to claim 8, further comprising an inspection assembly, with the inspection assembly connected with the central processing controller, and configured to perform a first quality inspection on the food material and store a first quality inspection result into the first food quality parameter group before the first high-pressure-process is performed on the food material, and to perform a second quality inspection on the intermediate product and store a second quality inspection result into the second food quality parameter group before the second high-pressure-process is performed on the intermediate product, wherein the inspection assembly comprises one or both of a hardness tester and a pH meter.

10. The apparatus according to claim 8, wherein the pressurizer comprises a liquid pressure source, an gas pressure source and a pH regulator, the gas pressure source is configured to supply one or both of acid gas and alkaline gas, the liquid pressure source and the gas pressure source are configured to generate a medium for pressure transmission, and the pH regulator is configured to control a content of one or both of the acid gas and alkaline gas in the medium so as to regulate a pH value of the medium.
